(19) United States
(12) Patent Application Publication
(10) Pub. No.: US 2005/0030853 A1
(43) Pub. Date: Feb. 10, 2005

(54) Information storage medium and method and apparatus for recording and/or reproducing data

(75) Inventors: Kyung-geun Lee, Gyeonggi-do (KR); Jung-wan Ko, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/879,537

(22) Filed: Jun. 30, 2004

Related U.S. Application Data
(60) Provisional application No. 60/483,231, filed on Jun. 30, 2003.

(30) Foreign Application Priority Data
Sep. 9, 2003 (KR) 2003-63411

(51) Int. Cl. G11B 5/09

(52) U.S. Cl. 369/47.22; 369/53.2

(57) ABSTRACT

An information storage medium including: a common information table which store information common to plural types of information storage media; at least one parameter table which store parameter information corresponding to a recording characteristic specific to the type of an information storage medium; and a pointer field which stores pointer information indicating a location of the at least one parameter table.

### CROSS-REFERENCE TO RELATED APPLICATIONS

This application claims the benefit of Korean Patent Application No.2003-63411, filed on Sep. 9, 2003, in the Korean Intellectual Property Office, and the benefit of U.S. Provisional Patent Application No. 60/483,231, filed on Jun. 30, 2003, the disclosures of which are incorporated herein by reference.

### BACKGROUND OF THE INVENTION

1. Field of the Invention

The present invention relates to an information storage medium and a method and apparatus for recording and/or reproducing pointing information, and more particularly, to an information storage medium which stores changeable information among information related to the information storage medium and pointing information about the locations of the changeable information, and a method and apparatus for recording/reproducing data.

2. Description of Related Art

General optical disks are widely used as information recording media of optical pickup apparatuses for recording/reproducing data in a non-contact way. Optical disks are classified as compact disks (CDs) or digital versatile disks (DVDs) according to their information storage capacity. Examples of recordable optical disks include 650MB CD−R, CD−RW, 4.7GB DVD+RW, and the like. Examples of reproduction-only optical disks include 650MB CD, 4.7GB DVD−ROM, and the like. Furthermore, HD-DVDs having a recording capacity of 25GB or greater are under development.

FIG. 1A illustrates a layout of a recordable information storage medium, and FIG. 1B illustrates a layout of a reproduction-only information storage medium. A general information storage medium includes a lead-in zone, a data zone, and a lead-out zone. The lead-in zone stores disc-related information and the like. When disc-related information is recorded in a recordable information storage medium, it is recorded in the form of pits or wobbles. On the other hand, when disc-related information is recorded in a reproduction-only information storage medium, it is recorded in the form of pits. The general information storage medium further includes a defect management area (DMA), a buffer zone, an optimal power control (OPC) test zone, a reserved area, and the like.

Examples of disk-related information include the type of a disk, the version number thereof, the size thereof, the number of information storage layers, information about a writing strategy (e.g., a recording speed, recording or reproduction power, and the like), and the like. Referring to FIG. 2, parameters related to a writing strategy include initial pulse time Ttop at the start of writing, multi-pulse time Tmp in the middle of writing, cooling pulse time Tcl at the end of writing, writing power Pw, erasing power Pe, bias power Pb, and the like.

As illustrated in FIGS. 3A through 3F, a conventional information storage medium stores information that varies every time part of disk-related information is changed. However, some of disk-related information examples are common to all types of disks, and some are changeable depending on the type of a disk. Examples of the changeable information include the number of recording layers, recording speed information, writing strategy information, and the like. These changeable information pieces are recorded together with common information in different areas.

When an information storage medium is loaded on a drive, the drive reads out all kinds of disk-related information, ascertains suitable conditions, and records or reproduces data in the information storage medium according to the suitable conditions. However, if the disk-related information increases, the drive requires a large amount of time to read all of the disk-related information. This causes a commencement of data recording/reproduction to be delayed.

The disk-related information can be recorded in many ways according to the format of an information storage medium. For example, data may be recorded in the form of pits in reproduction-only information storage media. In particular, data may be recorded in the form of groove wobbles in recordable information storage media. A channel for data recorded in the form of pits is a differential channel, and a channel for data recorded in the form of groove wobbles is a sum channel. When the disk-related information is recorded in the form of groove wobbles, a physical length corresponding to some bits is longer than when the disk-related information is recorded in the form of pits. Hence, when identical information is read-out, it takes longer in the former case than in the latter case. As a result, much time is wasted before user data is actually recorded or reproduced.

### BRIEF SUMMARY

The present invention provides an information storage medium which stores changeable information among information related to the information storage medium and pointing information about the locations of the changeable information so that the information can be effectively and rapidly accessed, and a method and apparatus for recording/reproducing data.

According to an aspect of the present invention, there is provided an information storage medium including: a common information table which stores information common to plural types of information storage media; at least one parameter table which stores parameter information corresponding to a recording characteristic specific to the information storage medium; and a pointer field which stores pointer information indicating a location of the at least one parameter table.

The parameter information may be at least one of speed information, parameters related to a writing strategy, information about an information storage layer, a version number of an information storage medium, and a writing-related parameter.

A common information table and a pointer field may be allocated to each parameter table.

According to another aspect of the present invention, there is provided a method of recording data to and/or reproducing data from an information storage medium, including: recording information common to plural types of information storage media in a common information table; recording parameter information corresponding to a recording characteristic specific to the information storage medium, in at least one parameter table; recording pointer information indicating a location of the at least one parameter table; reading the pointer information to locate a parameter table; and reproducing data from the information storage medium according to the read-out parameter information at the located parameter table.

According to still another aspect of the present invention, there is provided an apparatus for recording data onto an information storage medium, including: a writer which writes data onto the information storage medium; and a controller which controls the writer to write pointer information indicating a location of a disk-related information area in the disk-related information area.

According to still another aspect of the present invention, there is provided a method of recording data on an information storage medium, including: recording information common to plural types of information storage media in a common information table; recording parameter information corresponding to a recording characteristic specific to the information storage medium, in at least one parameter table; and recording pointer information indicating a location of the at least one parameter,table.

According to yet another aspect of the present invention, there is provided method of reproducing data from an information storage medium, including: reading the pointer information indicating a location of an at least one parameter table, the at least one parameter table containing parameter information corresponding to a recording characteristic specific to the information storage medium; and reproducing data from the information storage medium according to the read-out parameter information at the located parameter table.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1A shows a layout of a conventional recordable information storage medium;

FIG. 1B shows a layout of a conventional reproduction-only information storage medium;

FIG. 2 shows general recording-related parameters together with a writing pulse pattern;

FIGS. 3A through 3F show examples of an area of a conventional information storage medium in which disk-related information is recorded;

FIG. 4 shows an information storage medium according to an embodiment of the present invention in which disk-related information and pointing information about the location of the disk-related information are recorded;

FIG. 5 shows a variation of an information storage medium according to an embodiment of the present invention;

FIG. 6 is a flowchart illustrating a method of recording and/or reproducing pointing information in an information storage medium according to an embodiment of the present invention;

FIG. 7 is a block diagram of an apparatus for recording and/or reproducing data in an information storage medium, according to an embodiment of the present invention; and

FIG. 8 is a block diagram of a disk drive in which the apparatus of FIG. 7 is implemented.

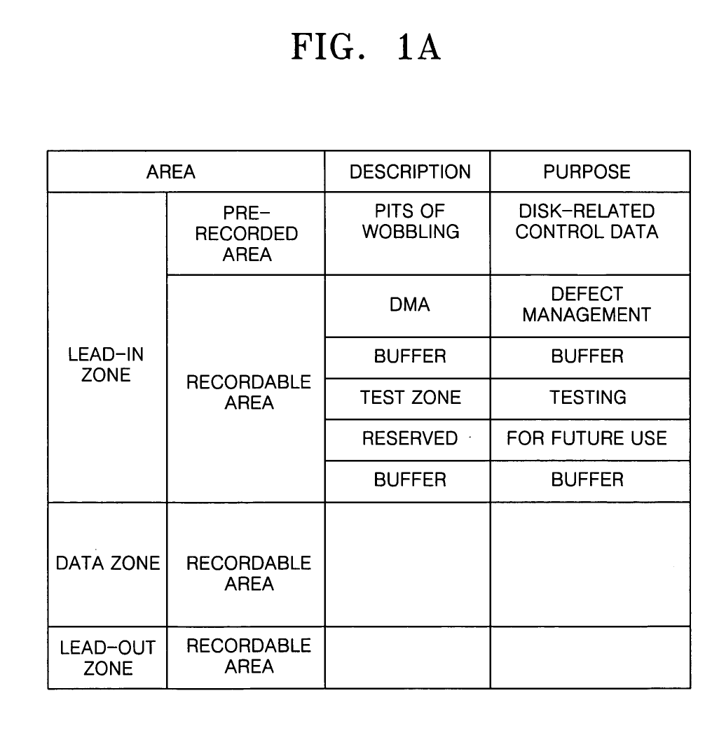

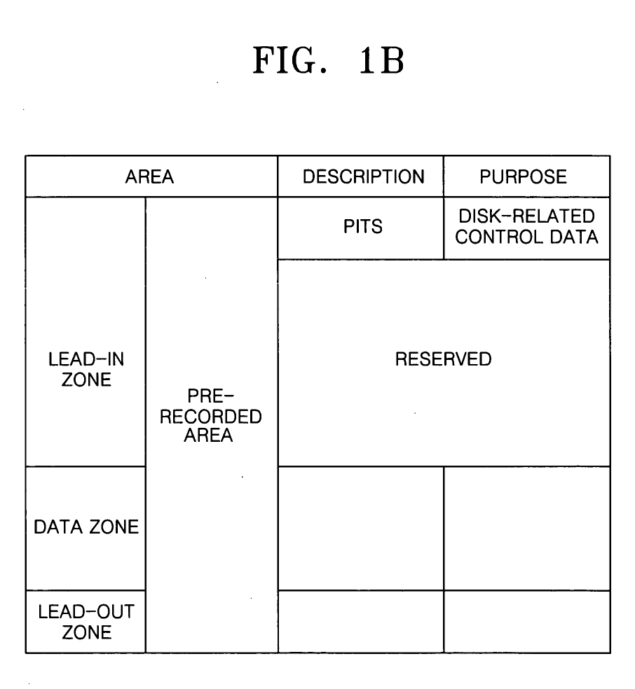

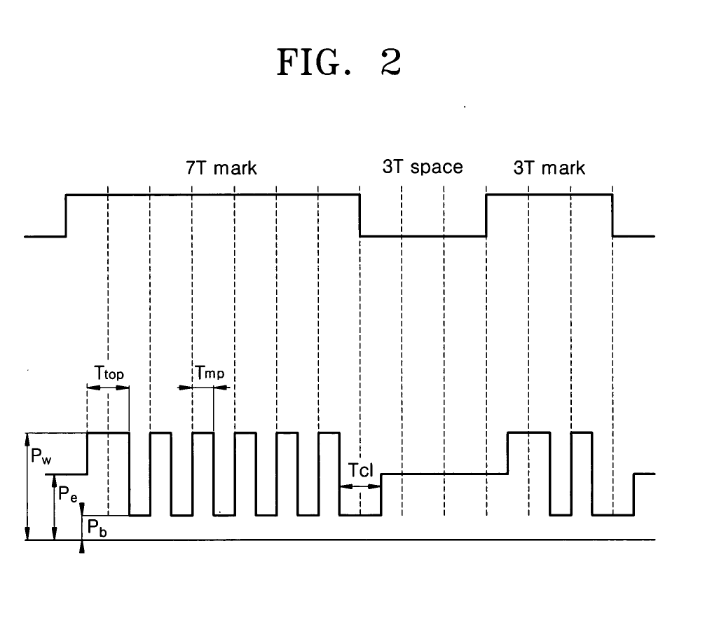

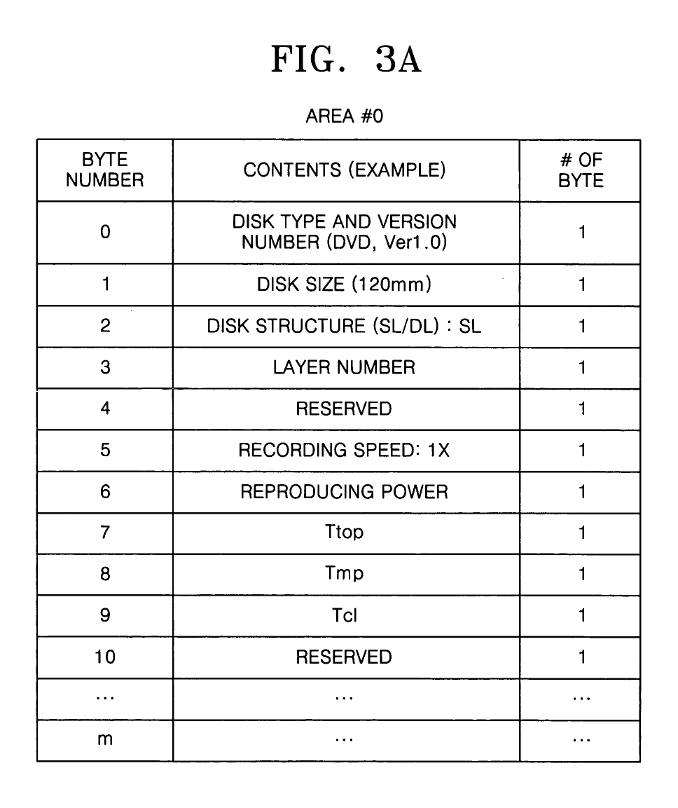

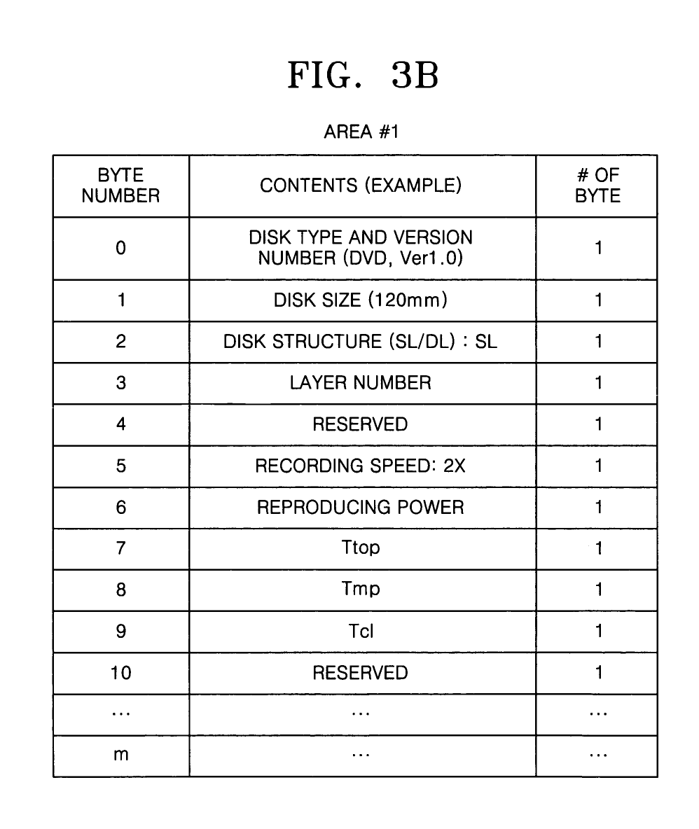

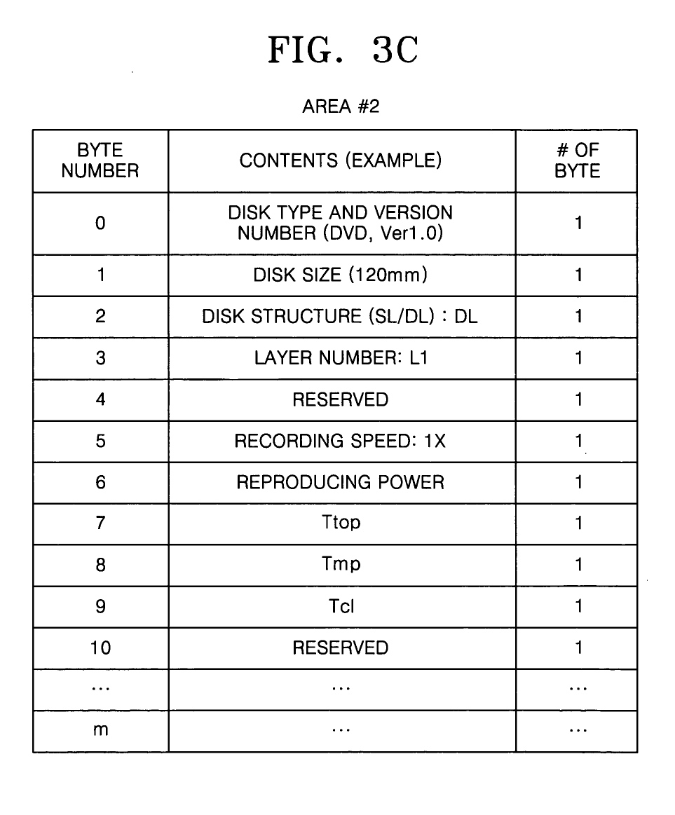

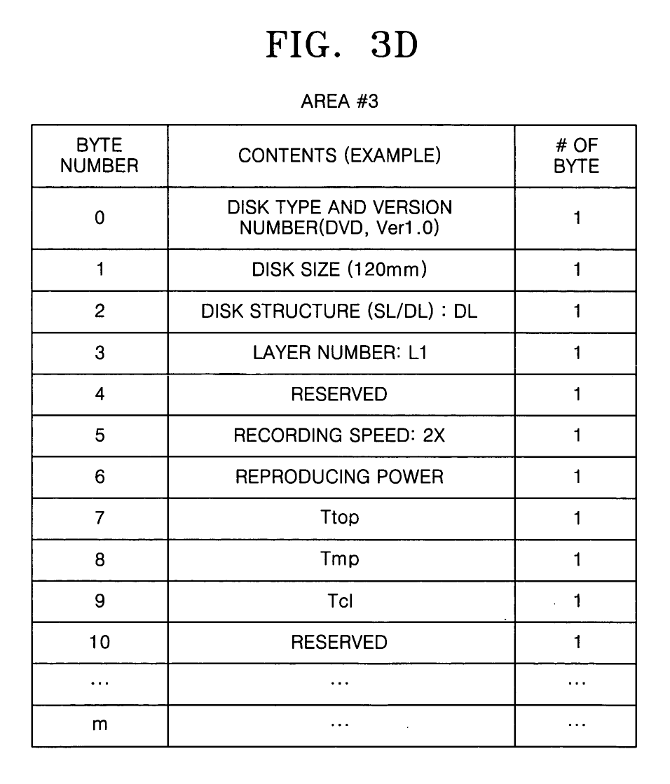

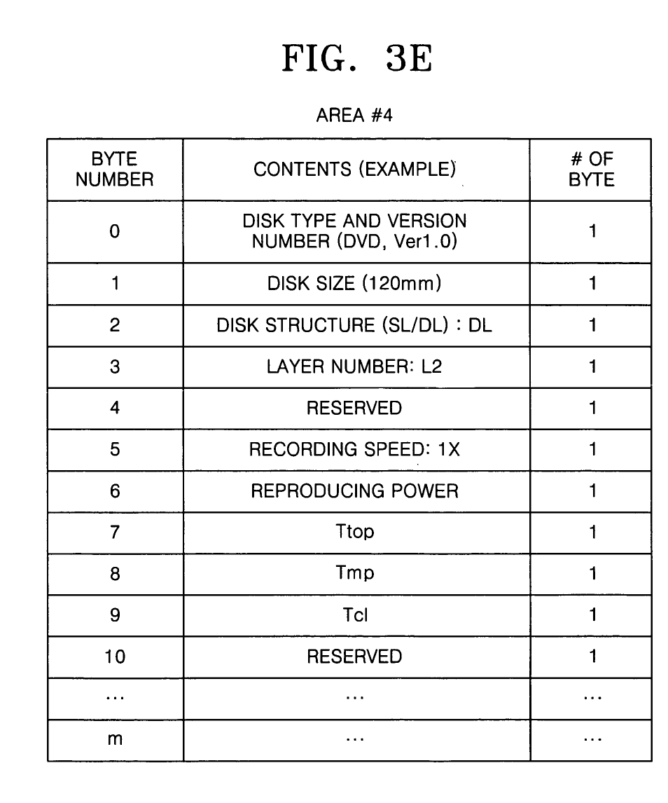

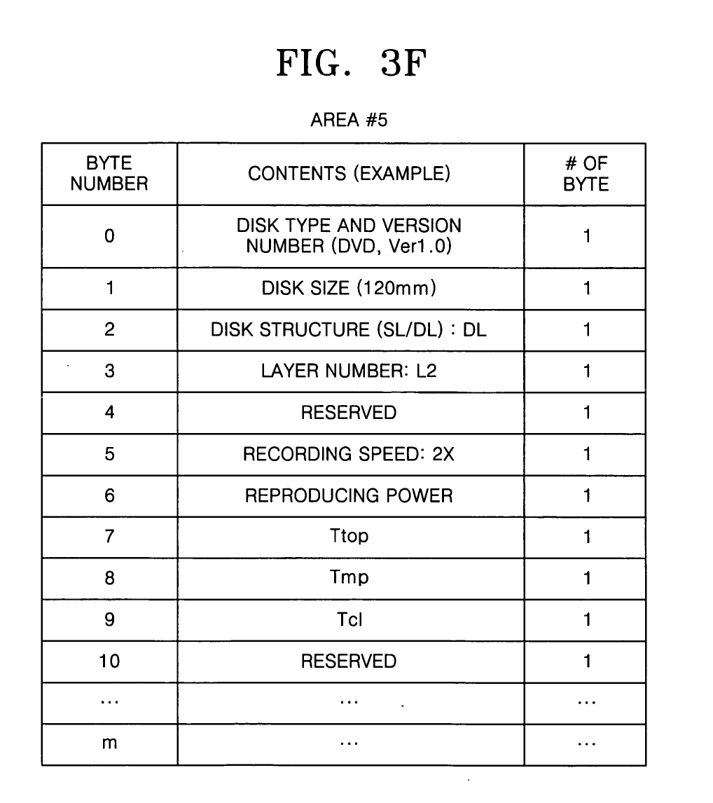

### DETAILED DESCRIPTION OF EMBODIMENT

Reference will now be made in detail to an embodiment of the present invention, an example of which is illustrated in the accompanying drawings, wherein like reference numerals refer to the like elements throughout. The embodiment is described below in order to explain the present invention by referring to the figures.

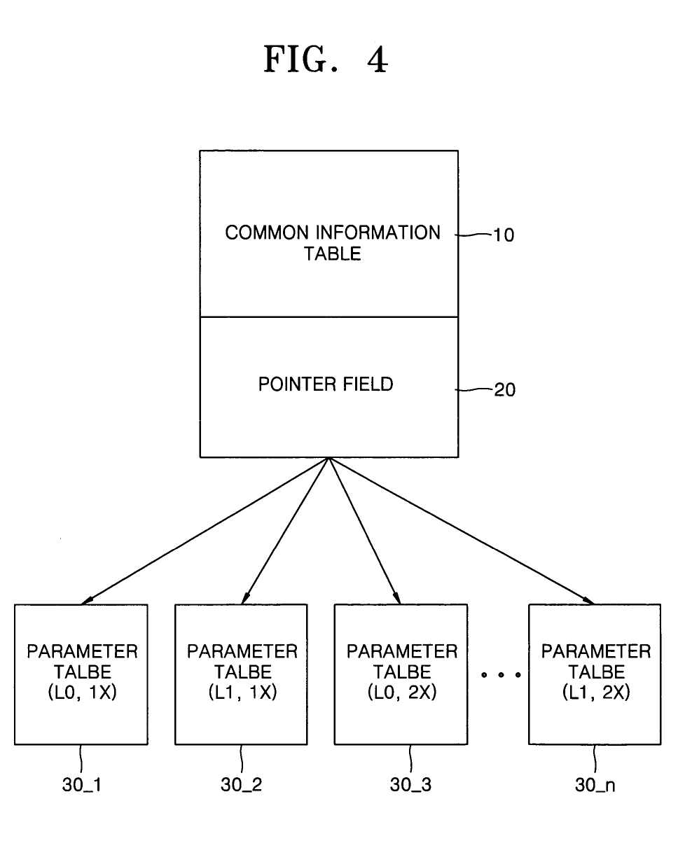

Referring to FIG. 4, common disc-related information is recorded in a common information table 10 and pointer information indicating the locations of changeable parameters is recorded in a pointer field 20, which is next to the common information table 10, so that disc-related information can be read by a drive in which an information storage medium is loaded.

The changeable parameters are recorded in parameter tables 30₁₃ 1, 30₁₃ 2, 30₁₃ 3, . . . , and 30₁₃ n, which are different from the common information table 10 and the pointer field 20.

The changeable parameters may be information pieces that change with an increase of information storage layers, diversifications of a recording speed, and a writing strategy (WS).

Examples of the common information recorded in the common information table 10 include types of information storage media (e.g., a reproduction-only information storage medium, a write-once information storage medium, or a rewritable information storage medium), a recording speed range, and the like. The recording speed range may be represented with a minimum recording speed and a maximum recording speed. The number of recording speeds covered by the loaded information storage medium may be an example of the common information.

Examples of the changeable parameters include a recording speed, the number of information storage layers, a writing strategy, and the like. The changeable parameters may change depending on the type of information storage medium.

For example, the changeable parameters are recorded at different locations in a disk-related information area. Pointer information indicating the locations of the changeable parameters is recorded in the pointer field 20. The pointer field 20 may be included in the common information table 10 or an area separate from the common information table 10.

An example where a bit combination representing pointer information is recorded in the pointer field 20 is shown in Table 1. If information about multiple speeds of each information storage layer is recorded as a changeable parameter, pointer information corresponding to the information about the multiple speeds of each information storage layer is recorded in a pointer field as illustrated in Table 1.

TABLE 1

| Bit combination | Pointer information |
|---|---|
| 0000 0000b | First area |
| 0000 0001b | Single layer, 1x-speed, second area |
| 0000 0010b | Single layer, 2x-speed, third area |
| 0000 0011b | Single layer, 3x-speed, fourth area |
| . . . | |
| 0001 0000b | Dual layer, first layer, 1x-speed, n − th area |
| 0010 0000b | Dual layer, second layer, 1x-speed, (n + 1)th area |
| 0011 0000b | Dual layer, first layer, 2x-speed, (n + 2)th area |
| 0100 0000b | Dual layer, second layer, 2x-speed, (n + 3)th area |
| . . . | |

Since pointer information indicating the locations of the parameter tables is recorded as described above, additional information can be read out by recording pointer information indicating the location of the additional information in the pointer field 20. Hence, the compatibility of information storage media with a drive is improved.

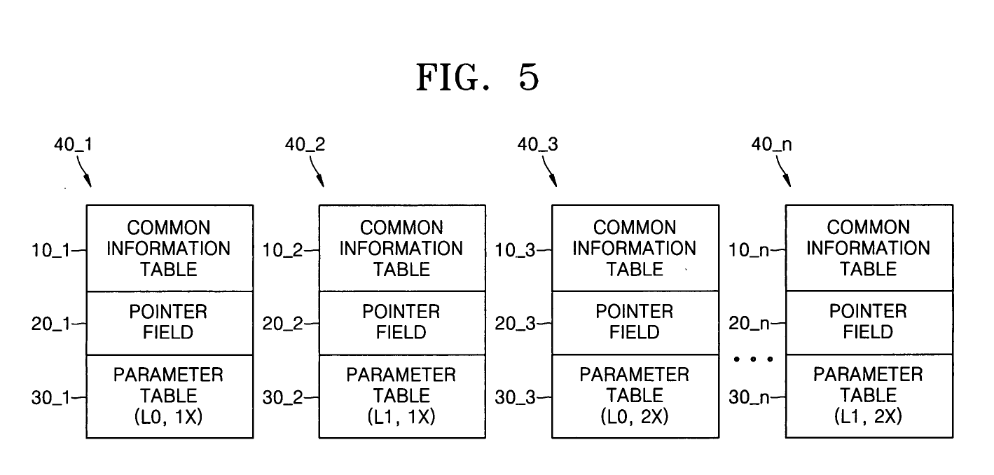

Referring to FIG. 5, an area for disk-related information includes first through n-th areas 40₁₃ 1, 40₁₃ 2, 40₁₃ 3, . . . , and 40₁₃ n, which include common information tables 10₁₃ 1, 10₁₃ 2, 10₁₃ 3, . . . , and 10₁₃ n, respectively, pointer fields 20₁₃ 1, 20₁₃ 2, 20₁₃ 3, . . . , and 20₁₃ n, respectively and parameter tables 30₁₃ 1, 30₁₃ 2, 30₁₃ 3, . . . , and 30₁₃ n, respectively.

Identical information common to all kinds of information storage media is recorded in the common information tables 10₁₃ 1, 10₁₃ 2, 10₁₃ 3, . . . , and 10₁₃ n. Changeable parameters, which are changeable information, are separately recorded in the parameter tables 30₁₃ 1, 30₁₃ 2, 30₁₃ 3, . . . , and 30₁₃ n. Pointer information indicating the locations of the parameter tables 30₁₃ 1, 30₁₃ 2, 30₁₃ 3, . . . , and 30₁₃ n, where the changeable information is recorded, is commonly recorded in the pointer fields 20₁₃ 1, 20₁₃ 2, 20₁₃ 3, . . . , and 20₁₃ n.

As described above, necessary common information or necessary pointer information can be read out from any of the areas. Accordingly, changeable information can be accessed using the pointer information indicating the location of the changeable information.

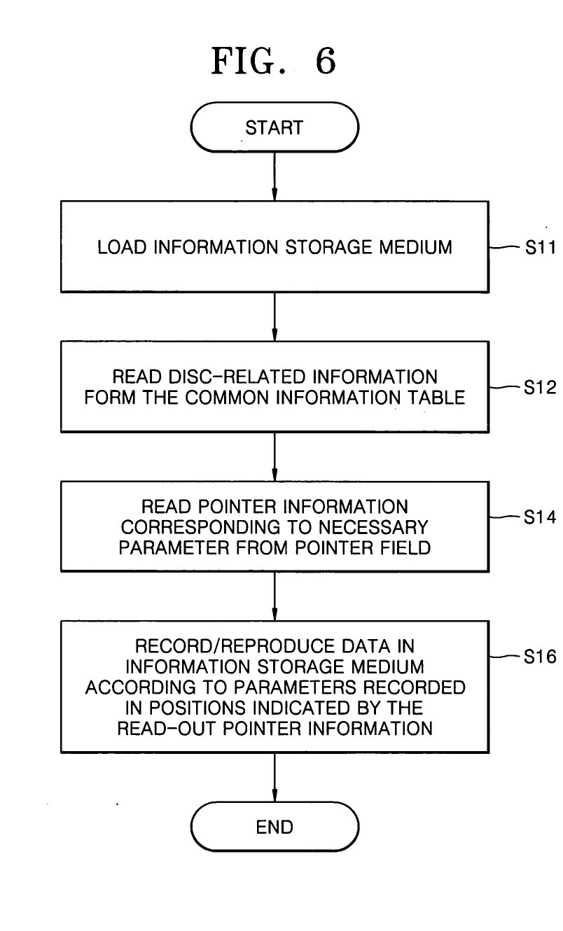

FIG. 6 is a flowchart illustrating a method of recording and/or reproducing data, according to an embodiment of the present invention.

In an information storage medium according to the present invention, a disk-related information area includes a common information table, parameter tables, and a pointer field. The common information table stores disc-related information that is common to all types of information storage media. The parameter tables store parameters that change depending on the type of an information storage medium used. The pointer field stores pointer information that indicates the locations of the parameters.

In a method of recording and/or reproducing data in the information storage medium, when the information storage medium is loaded in a drive in operation S11, disk-related information is read out from the common information table, in operation S12. Thereafter, pointer information indicating the location of a necessary parameter is read out from the pointer field, in operation S14. Next, data is recorded or reproduced in the information storage medium according to the parameter recorded in the location indicated by the read-out pointer information, in operation S16.

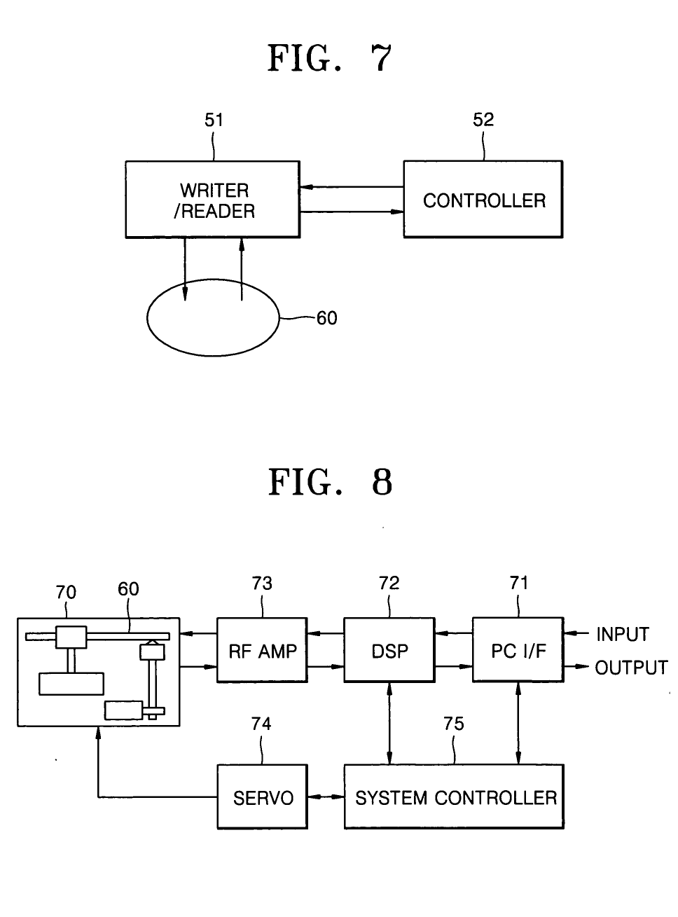

FIG. 7 is a block diagram of an apparatus for recording and/or reproducing data in an information storage medium, according to an embodiment of the present invention. The apparatus includes a writer/reader 51 and a controller 52. The writer/reader 51 writes data in an information storage medium 60 according to an embodiment of the present invention and reads the written data. The controller 52 controls the writer/reader 51 to write pointer information, which indicates an area where disc-related information is recorded according to the present embodiment, to the information storage medium 60 or to read the pointer information from the information storage medium 60 and access parameter information which is recorded in the area indicated by the read-out pointer information. Data is recorded or reproduced in or from the information storage medium 60 according to the read-out parameter information.

FIG. 8 is a block diagram of a disk drive in which the apparatus of FIG. 7 is implemented. Referring to FIG. 8, the disk drive includes a pickup 70 to serve as the writer/reader 51. The write-once recording medium 60 is installed on the pickup 70. The disk drive includes a PC I/F 71, a DSP 72, an RF AMP 73, a servo 74, and a system controller 75, all of which make up the controller 52.

Upon recording, the PC I/F 71 receives a recording command together with data to be recorded, from a host (not shown). The system controller 75 performs initialization necessary for recording. In other words, the system controller 75 reads information necessary for initialization, such as, disk information stored in a lead-in area of the information storage medium 60, and prepares for recording based on the information necessary for initialization. The DSP 72 performs ECC encoding on the data received from the PC I/F 71 by adding data, such as parity to the received data, and then modulates the ECC-encoded data in a predetermined manner. The RF AMP 73 converts the data received from the DSP 72 into an RF signal. The pickup 70 records the RF signal received from the RF AMP 73 to the information storage medium 60. The servo 74 receives a command necessary for servo control from the system controller 75 and servo-controls the pickup 70. If reproduction speed information is not recorded on the information storage medium 60, the system controller 75 commands the pickup 70 to write reproduction speed information according to the present invention in a predetermined area of the information storage medium 60 at the starting point of recording, in the middle of recording, or after the completion of recording.

Upon reproduction, the PC I/F 71 receives a reproduction command from the host (not shown). The system controller 75 performs initialization necessary for reproduction. In other words, the system controller 75 reads the reproduction speed information from the information storage medium 60 and reproduces data at a reproduction speed indicated by the reproduction speed information. The pickup 70 projects a laser beam onto the information storage medium 60, receives a laser beam reflected by the information storage medium 60, and outputs an optical signal. The RF AMP 73 converts the optical signal received from the pickup 70 into an RF signal, supplies modulated data obtained from the RF signal to the DSP 72, and supplies a servo control signal obtained from the RF signal to the servo 74. The DSP 72 demodulates the modulated data and outputs data obtained through ECC error correction. The servo 74 receives the servo control signal from the RF AMP 73 and a command necessary for servo control from the system controller 75 and servo-controls the pickup 70. The PC I/F 71 sends data received from the DSP 72 to the host.

As described above, pointer information indicating a location of changeable disk-related information is recorded in either a common information table included in a disk-related information area or an area separate from the common information table that is included in the disk-related information. Accordingly, even when the amount of the changeable information increases, desired information can be reproduced.

Also, a data structure of an information storage medium according to the present embodiment is applicable to a reproduction-only disc, a rewritable disc, a write-once disc, and the like. Furthermore, the data structure of the information storage medium according to the present invention is applicable to an information storage medium having one or more information storage layers.

According to the present embodiment, since pointer information indicating a location of changeable disk-related information is recorded in an information storage medium, a drive can reproduce desired information even when the amount of the changeable information increases. In other words, necessary information can be read out based on the pointer information, thereby reducing the time required to perform recording/reproduction.

Although an embodiment of the present invention have been shown and described, the present invention is not limited to the described embodiment. Instead, it would be appreciated by those skilled in the art that changes may be made in the embodiment without departing from the principles and spirit of the invention, the scope of which is defined by the claims and their equivalents.

1. An information storage medium comprising:
a common information table which stores information common to plural types of information storage media;
at least one parameter table which stores parameter information corresponding to a recording characteristic specific to the information storage medium; and
a pointer field which stores pointer information indicating a location of the at least one parameter table.

2. The information storage medium of claim 1, wherein the parameter information is at least one of speed information, parameters related to a writing strategy, information about an information storage layer, a version number of an information storage medium, and a writing-related parameter.

3. The information storage medium of claim 1, wherein a common information table and a pointer field are allocated to each parameter table.

4. The information storage medium of claim 2, wherein a common information table and a pointer field are allocated to each parameter table.

5. The information storage medium of claim 1, wherein the parameter information is recorded in an area different from the common information table and the pointer field.

6. The information storage medium of claim 1, wherein the parameter information changes with at least one of an increase of information storage layers, diversifications of a recording speed, and a writing strategy.

7. The information storage medium of claim 1, wherein the common information includes at least one of a type of information storage media, a recording speed range, and number of recording speeds.

8. The information storage medium of claim 7, wherein recording speed range is represented by a minimum recording speed and a maximum recording speed.

9. The information storage medium of claim 1, wherein the parameter information includes at least one of a recording speed, the number of information storage layers, and a writing strategy.

10. The information storage medium of claim 1, wherein the parameter information changes depending on the type of an information storage medium.

11. The information storage medium of claim 1, wherein the pointer field is recorded in the common information table.

12. A method of recording data to and/or reproducing data from an information storage medium, comprising:
recording information common to plural types of information storage media in a common information table;
recording parameter information corresponding to a recording characteristic specific to the information storage medium, in at least one parameter table;
recording pointer information indicating a location of the at least one parameter table;
reading the pointer information to locate a parameter table; and
reproducing data from the information storage medium according to the read-out parameter information at the located parameter table.

13. The method of claim 12, wherein the parameter information is at least one of speed information, parameters related to a writing strategy, information about an information storage layer, a version number of an information storage medium, and a writing-related parameter.

14. The method of claim 12, wherein the common information and the pointer information are recorded for each of the at least one parameter table.

15. The method of claim 12, wherein the pointer information is recorded in one of the common information table.

16. An apparatus for recording data onto an information storage medium, comprising:
a writer which writes data onto the information storage medium; and
a controller which controls the writer to write pointer information indicating a location of a disk-related information area in the disk-related information area.

17. The apparatus of claim 16, wherein the disk-related parameter information is recorded in at least one parameter table, wherein common information common to various types of recording media and the pointer information are recorded for each parameter table.

18. The apparatus of claim 16, wherein the pointer information is recorded in the common information table.

19. A method of recording data on an information storage medium, comprising:
recording information common to plural types of information storage media in a common information table;
recording parameter information corresponding to a recording characteristic specific to the information storage medium, in at least one parameter table; and
recording pointer information indicating a location of the at least one parameter table.

20. A method of reproducing data from an information storage medium, comprising:
reading the pointer information indicating a location of an at least one parameter table, the at least one parameter table containing parameter information corresponding to a recording characteristic specific to the information storage medium; and
reproducing data from the information storage medium according to the read-out parameter information at the located parameter table.
